(19) United States
(12) Patent Application Publication
(10) Pub. No.: US 2026/0077779 A1
(43) Pub. Date: Mar. 19, 2026

(54) Method and Device for the Transition Between Different Specifications in the Guidance of a Vehicle

(71) Applicant: Bayerische Motoren Werke Aktiengesellschaft, Muenchen (DE)

(72) Inventors: Thomas ROSSRUCKER, Eiselfing (DE); Thomas SPICHTINGER, Burglengenfeld (DE)

(21) Appl. No.: 19/326,868

(22) Filed: Sep. 12, 2025

(30) Foreign Application Priority Data
Sep. 13, 2024 (DE) 10 2024 126 386.5

(51) Int. Cl. B60W 50/08; B60W 50/00; B60W 60/00

(52) U.S. Cl. CPC B60W 50/085; B60W 60/0051; B60W 60/0053; B60W 2050/0025; B60W 2540/10; B60W 2540/12; B60W 2540/18

(57) ABSTRACT

A device that controls the longitudinal and/or lateral guidance of a vehicle by different units is described. The device is configured to determine a first setpoint torque predetermined by a first unit as a specification for a longitudinal and/or lateral guidance actuator of the vehicle, and to determine a second setpoint torque predetermined by a second unit as a specification for the longitudinal and/or lateral guidance actuator of the vehicle. The device determines a resulting setpoint torque for actuating the longitudinal and/or lateral guidance actuator based on the first setpoint torque, the second setpoint torque, and a changeover function for the changeover between the first setpoint torque and the second setpoint torque.

### CROSS REFERENCE TO RELATED APPLICATION

This application claims priority under 35 U.S.C. § 119 from German Patent Application No. 10 2024 126 386.5, filed Sep. 13, 2024, the entire disclosure of which is herein expressly incorporated by reference.

### BACKGROUND AND SUMMARY

The invention relates to a method and a corresponding device for automated longitudinal and/or lateral guidance of a vehicle.

A vehicle can have one or more driving functions, in particular driver assistance functions, which are each designed to longitudinally and/or laterally guide the vehicle in an automated manner. The vehicle can have a speed and/or distance controller (for example, adaptive cruise control, ACC), which is configured to set, in particular to regulate, the driving speed of the vehicle (during a free journey without preceding vehicle) to a target speed, and/or to set, in particular to regulate, the distance of the vehicle to a preceding vehicle driving directly in front of the vehicle to a target distance.

Additionally to the one or more driving functions, the longitudinal and/or lateral guidance of the vehicle can be effectuated manually by the driver of the vehicle. The specifications for the longitudinal and/or lateral guidance of the vehicle can therefore be effectuated by different units (for example, one or more different driving functions and/or the driver (via the accelerator pedal, the brake pedal and/or the steering wheel)).

The present document relates to the technical object of effectuating comfortable and reliable longitudinal and/or lateral guidance of a vehicle by way of different (control) units.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for controlling the longitudinal and/or lateral guidance of a (motor) vehicle by way of different (control) units is described. The device can be directed to effectuating a transition of the control of the longitudinal and/or lateral guidance of a (motor) vehicle between different (control) units. The vehicle can be designed such that at one point in time (at any arbitrary point in time) only precisely one (control) unit always effectuates the control of the longitudinal and/or lateral guidance of the vehicle in each case.

Exemplary units (exemplary first units and/or second units) are
a driving function, in particular a driver assistance function, for automated longitudinal and/or lateral guidance of the vehicle; and/or
a control means (such as an accelerator pedal, a brake pedal and/or a steering means) for manual longitudinal and/or lateral guidance of the vehicle by the driver of the vehicle.

The device is configured to determine a first setpoint torque specified by a first unit of the vehicle as the specification for a longitudinal and/or lateral guidance actuator of the vehicle. The first setpoint torque can change over time (for example, depending on the deflection of the manual control means and/or depending on the operating state of the driving function).

The device is furthermore configured to determine a second setpoint torque specified by a (different) second unit as the specification for the longitudinal and/or lateral guidance actuator of the vehicle. The second setpoint torque can change over time (for example, depending on the deflection of the manual control means and/or depending on the operating state of the driving function).

Furthermore, the device is configured to determine a resulting setpoint torque for actuating the longitudinal and/or lateral guidance actuator based on the first setpoint torque, based on the second setpoint torque, and based on a changeover function for changing over between the first setpoint torque and the second setpoint torque. By providing and using a changeover function, a comfortable and reliable transition of the control of the longitudinal and/or lateral guidance between different units of the vehicle can be effectuated. A fluid transition of the resulting setpoint torque between the first setpoint torque and the second setpoint torque can be effectuated by the changeover function.

The first setpoint torque, the second setpoint torque and/or the resulting setpoint torque can each relate to the torque or moment at one or more wheels of the vehicle. The first setpoint torque, the second setpoint torque and/or the resulting setpoint torque can each be wheel torques.

The device can furthermore be configured to operate the longitudinal and/or lateral guidance actuator (e.g., a drive motor, a brake actuator and/or a steering actuator) of the vehicle depending on the resulting setpoint torque to guide the vehicle longitudinally and/or laterally. The resulting setpoint torque can be used here as a setpoint variable for a control system.

A device is therefore described which enables different units of a vehicle to each provide specifications for the control of the longitudinal and/or lateral guidance of the vehicle, between which it is possible to change over in a fluid manner during a transition of the control of the longitudinal and/or lateral guidance between different units. A comfortable (smooth) transition of the control of the longitudinal and/or lateral guidance between the different units can be effectuated by the uniform specification of setpoint torques by the different units.

The device can be configured to determine the first setpoint torque based on a setpoint acceleration specified and/or determined by the first unit. For example, a setpoint acceleration can be determined by a regulator of the first unit. This can be converted into a corresponding setpoint torque to ensure that a setpoint torque is specified by each of the different units, so that a comfortable (smooth) transition of the control of the longitudinal and/or lateral guidance between the different units can be effectuated.

The changeover function can specify a changeover value as a function of time. The changeover value can change over time, in particular during a transition of the control of the longitudinal and/or lateral guidance from one unit to another unit. On the other hand, the changeover value can be constant over time if the control of the longitudinal and/or lateral guidance is (permanently) effectuated by a specific unit.

The device can be configured to determine the changeover value of the changeover function for the respective point in time in each case at one point in time from a sequence of successive points in time. Furthermore, the device can be configured to determine the resulting setpoint torque for the respective point in time based on the first setpoint torque for the respective point in time, based on the second setpoint torque for the respective point in time, and based on the changeover value for the respective point in time.

The resulting setpoint torque for the respective point in time can be determined as the weighted mean value of the first setpoint torque for the respective point in time and the second setpoint torque for the respective point in time. The weights for determining the weighted mean value can depend here on the changeover value for the respective point in time. The changeover function can adopt, for example, possibly exclusively, changeover values between 0 and 1. The weight for weighting the first setpoint torque can correspond to the changeover value. On the other hand, the weight for weighting the second setpoint torque can correspond to 1 minus the changeover value.

The respective resulting setpoint torque for a sequence of successive points in time can thus be determined in an efficient and precise manner. The changeover value can be adapted fluidly (for example, increased or reduced) for a transition of the control of the longitudinal and/or lateral guidance between different units.

The device can be configured to use the second setpoint torque as the resulting setpoint torque if the longitudinal and/or lateral guidance of the vehicle is controlled by the second unit. In this case, the changeover function can have (possibly permanently) a second value (for example, 0 or 1). Furthermore, the device can be configured to use the first setpoint torque as the resulting setpoint torque if the longitudinal and/or lateral guidance of the vehicle is controlled by the first unit. In this case, the changeover function can have (possibly permanently) a first value (for example, 1 or zero (in a complementary manner to the second value)).

The device can be configured, in the context of a transition of the control of the longitudinal and/or lateral guidance of the vehicle between the first unit and the second unit, to use a value between the first setpoint torque and the second setpoint torque as the resulting setpoint torque, which depends on the changeover value dependent on the changeover function. The changeover value can have a value between the first and the second value. During a transition of the control from the first unit to the second unit, the changeover value can be fluidly converted from the first value to the second value. During a transition of the control from the second unit to the first unit, the changeover value can be fluidly converted from the second value to the first value. A particularly comfortable and reliable transition of the control of the longitudinal and/or lateral guidance between different units can thus be effectuated.

The device can be configured to determine at a first point in time that a transition of the control of the longitudinal and/or lateral guidance of the vehicle from the second unit to the first unit takes place. The transition can have been initiated, for example, by a driving function or by the driver.

The device can furthermore be configured, in reaction to the determination, in a time interval which extends from the first point in time to a (following) second point in time, to change the resulting setpoint torque from the second setpoint torque to the first setpoint torque depending on the changeover function. The changeover values of the changeover function can pass fluidly from the second value to the first value in the time interval from the first point in time to the second point in time. The second point in time can follow the first point in time, for example, by 0.5 seconds or more, or by one second or more.

As already described, the resulting setpoint torque can correspond to the second setpoint torque if the changeover value has the second value. Furthermore, the resulting setpoint torque can correspond to the first setpoint torque if the changeover value has the first value. Furthermore, the resulting setpoint torque can have a value between the second setpoint torque and the first setpoint torque if the changeover value is between the second value and the first value.

A particularly comfortable and reliable transition of the control of the longitudinal and/or lateral guidance between different units can thus be effectuated.

The changeover function can have a constant gradient in the time interval from the first point in time to the second point in time. On the other hand, the changeover function can have a changing temporal gradient in the time interval from the first point in time to the second point in time. The comfort of the transition of the control of the longitudinal and/or lateral guidance can thus be further increased.

According to a further aspect, a (road) motor vehicle (in particular a passenger vehicle or a truck or a bus or a motorcycle) is described, which comprises the device described in this document.

According to a further aspect, a method for controlling the longitudinal and/or lateral guidance of a (motor) vehicle by way of different units (in particular by a driving function and/or by one or more control means for manual longitudinal and/or lateral guidance, such as the accelerator pedal, the brake pedal and/or the steering means) is described.

The method comprises the determination of a first setpoint torque predetermined by a first unit as a specification for a longitudinal and/or lateral guidance actuator of the vehicle, and the determination of a second setpoint torque predetermined by a second unit as a specification for the longitudinal and/or lateral guidance actuator of the vehicle. Furthermore, the method comprises the determination of the resulting setpoint torque for actuating the longitudinal and/or lateral guidance actuator based on the first setpoint torque, based on the second setpoint torque, and based on a changeover function for the changeover between the first setpoint torque and the second setpoint torque.

It is to be noted that the aspects described in conjunction with the device, in particular the claims described in conjunction with the device, are also to be applied as corresponding method features to the method.

According to a further aspect, a software (SW) program is described. The SW program can be configured to be executed on a processor (for example, on a controller of a vehicle), and to thus carry out the method described in this document.

According to a further aspect, a storage medium is described. The storage medium can comprise an SW program, which is configured to be executed on a processor, and to thus carry out the method described in this document

It is to be noted that the methods, devices and systems described in this document can be used both alone and in combination with other methods, devices and systems described in this document. Furthermore, any aspects of the methods, devices and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments. In the figures

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIG. 2a shows an exemplary device for determining the setpoint torque for a longitudinal and/or lateral guidance actuator of the vehicle;

FIG. 2b shows an exemplary transition between different setpoint torques; and

FIG. 3 shows a flow chart of an exemplary method for taking into consideration different specifications in the longitudinal and/or lateral guidance of a vehicle.

### DETAILED DESCRIPTION OF THE DRAWINGS

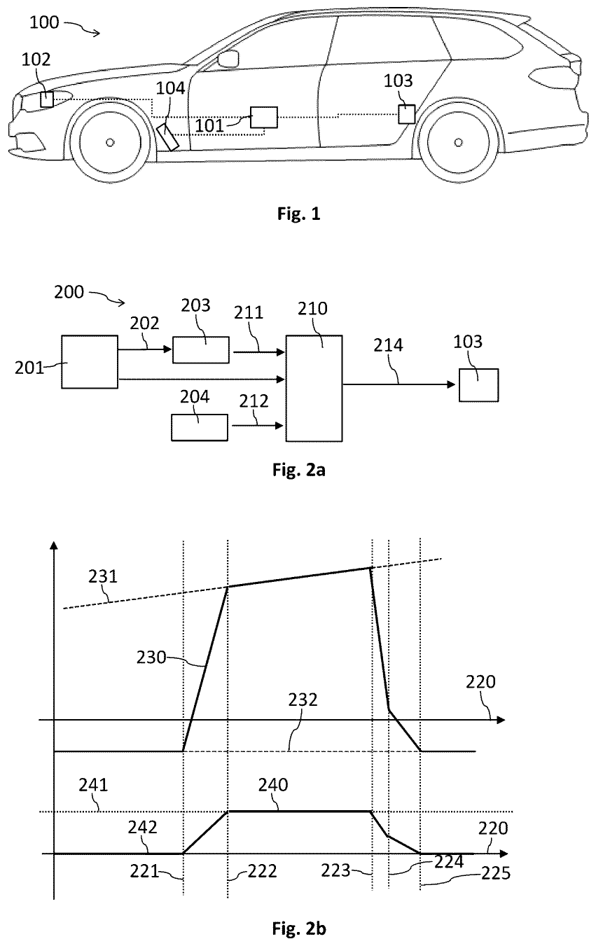

As described at the outset, the present document relates to the comfortable and reliable longitudinal and/or lateral guidance of a (motor) vehicle by different (control) units. In this context, FIG. 1 shows an exemplary vehicle 100 having one or more surroundings sensors 102, which are each configured to acquire sensor data (which are also referred to as surroundings data) with respect to the surroundings of the vehicle 100. Exemplary surroundings sensors 102 are a camera, a radar sensor, a lidar sensor, an ultrasonic sensor, etc.

A (control) device 101 of the vehicle 100 can be configured to evaluate the surroundings data, for example, to detect one or more objects (such as other vehicles) in the surroundings of the vehicle 100. The device 101 can furthermore be configured to effectuate automated longitudinal and/or lateral guidance of the vehicle 100 on the basis of the surroundings data, in particular on the basis of the one or more detected objects. For this purpose, one or more longitudinal and/or lateral guidance actuators 103 (e.g., a drive motor, a braking device and/or a steering device) of the vehicle can be actuated.

The automatic longitudinal guidance of the vehicle 100 can be effectuated, for example, by a speed and/or distance regulator. The speed and/or distance regulator can be viewed as a (control) unit, by which specifications are made with respect to the longitudinal and/or lateral guidance of the vehicle 100. A further (control) unit of the vehicle 100 is the accelerator pedal, the brake pedal and/or the steering means (in particular the steering wheel), by each of which specifications with respect to the longitudinal and/or lateral guidance of the vehicle 100 can be made manually by the driver of the vehicle 100. The specifications can relate, for example, to a (longitudinal and/or lateral) acceleration of the vehicle 100.

During the operation of the vehicle 100, a transition of the control of the longitudinal and/or lateral guidance of the vehicle 100 from a first (control) unit to another second (control) unit can occur. For example, the control of the longitudinal and/or lateral guidance can be transferred from a driving function (as a first unit) to the driver (wherein then one or more control means 104, e.g., the accelerator pedal, the brake pedal and/or the steering means, form the second unit), or vice versa. In the context of the transition, a transition occurs from the specification for the longitudinal and/or lateral guidance of the first unit to the specification of the second unit.

One or more measures are described in this document, which enable a fluid and/or comfortable (in particular free of jumps and/or jerks) transition from the specification of a first unit to the specification of a second unit. For this purpose, specifications with respect to the setpoint torque are provided at each of one or more wheels of the vehicle 100. This has the advantage that discontinuities can be avoided by the specification of the setpoint torque, which could result alternatively upon use of the setpoint acceleration as the specification if, in the context of the operation of the vehicle 100, an erroneous value of the vehicle mass and/or an erroneous value for the radius of the one or more wheels of the vehicle 100 is used.

A first setpoint torque can be defined by the first unit as a specification for the longitudinal and/or lateral guidance, and a second setpoint torque, which differs from the first setpoint torque, can be defined by the second unit. For the transition of the control of the longitudinal and/or lateral guidance of the vehicle 100 from the first unit to the second unit, a fluid transition of the setpoint torque from the first setpoint torque to the second setpoint torque can be effectuated (for example, by means of a changeover function). A comfortable and stable control of the longitudinal and/or lateral guidance by different (control) units of the vehicle 100 can thus be effectuated.

FIG. 2a shows an exemplary device 200, 101 for determining the resulting setpoint torque 214 as a specification for the operation of a (longitudinal and/or lateral guidance) actuator 103 of the vehicle 100. A setpoint acceleration 202 can be defined as a specification by a first unit 201 (for example, by a driving function, in particular a driver assistance function). The setpoint acceleration 202 can be converted by a conversion unit 203 into a first setpoint torque 211. The setpoint torque can relate here to a setpoint wheel torque, i.e. to a setpoint torque which is to be provided at a (driven) wheel of the vehicle 100. Furthermore, a second setpoint torque 212 (in particular a second setpoint wheel torque) can be defined by a second unit 204 (for example, manually by the driver by actuating the accelerator pedal and/or the brake pedal and/or the steering means (i.e., by actuating a control means 104)).

In a changeover unit 210, the resulting setpoint torque 214 (in particular the resulting wheel setpoint torque) can be determined as a specification for the actuator 103 (using a changeover function). The resulting setpoint torque 214 can lie here between the first setpoint torque 211 and the second setpoint torque 212.

FIG. 2b shows an exemplary chronological progression 231 of the first setpoint torque 211 (as a function of the time 220). Furthermore, FIG. 2b shows an exemplary chronological progression 232 of the second setpoint torque 212 (as a function of the time 220). Furthermore, FIG. 2b shows an exemplary chronological progression 230 of the resulting setpoint torque 214 (as a function of the time 220).

Furthermore, FIG. 2b shows an exemplary changeover function 240, which specifies changeover values as a function of the time 220. The changeover values can be, for example, arbitrary values between a first value 241 (for example, “0”) and a second value 242 (for example, “1”). The resulting setpoint torque 214 can correspond to the first setpoint torque 211 at a point in time 220 if the changeover function 240 has the first value 241 at this point in time 220. On the other hand, the resulting setpoint torque 214 can correspond to the second setpoint torque 212 at a point in time 220, if the changeover function 240 has the second value 242 at this point in time 220. Furthermore, the resulting setpoint torque 214 can correspond to a value between the first setpoint torque 211 and the second setpoint torque 212 at a point in time 220 if the changeover function 240 has a changeover value, which lies between the first value 241 and the second value 242, at this point in time 220.

In the example shown in FIG. 2b, the changeover function 240 has the second value 242 up to the first point in time 221, so that the resulting setpoint torque 214 corresponds to the second setpoint torque 232. At the first point in time 221, the transition of the control of the longitudinal and/or lateral guidance of the vehicle 100 from the second unit 204 to the first unit 201 can have been initiated or carried out (for example, because the driver of the vehicle 100 has activated the driving function associated with the first unit 201).

In reaction to the initiation of the transition, in the time interval between the first point in time 221 and the second point in time 222, the changeover values of the changeover function 240 can be converted fluidly (in particular linearly with a specific time gradient) from the second value 242 to the first value 241. As a result thereof, the resulting setpoint torque 214 changes fluidly in a corresponding manner (in particular linearly with a specific time gradient) from the second setpoint torque 212 to the first setpoint torque 211.

From the second point in time 222, the changeover function 240 can consistently remain at the first value 241, so that the resulting setpoint torque 214 always corresponds to the first setpoint torque 211.

At the third point in time 223, a transition of the control of the longitudinal and/or lateral guidance of the vehicle 100 from the first unit 201 to the second unit 204 can be initiated or carried out (for example, because the driver deactivates the driving function associated with the first unit 201, or because a transfer to the driver is initiated by the driving function). In reaction thereto, in the time interval from the third point in time 223 to the fifth point in time 225, the changeover function 240 can be fluidly converted from the first value 241 to the second value 242, so that the resulting setpoint torque 214 is fluidly converted from the first setpoint torque 211 to the second setpoint torque 212.

The time gradient, using which the changeover function 240 is changed over between the first value 241 and the second value 242, can optionally be varied. This is shown by way of example in FIG. 2b for the time interval from the third point in time 223 to the fifth point in time 225. In a first partial interval from the third point in time 223 to a fourth point in time 224, a different time gradient is used than in the following second partial interval from the fourth point in time 224 to the fifth point in time 225. The quality of the transition between the specifications of different (control) units 201, 204 can be further increased by the adaptation of the time gradient for the transition between different values of the changeover function 240.

The specifications of different (control) units 201, 204 can therefore each be formulated as setpoint torques 211, 212. A specification for a setpoint acceleration 202 can possibly be converted into a corresponding setpoint torque 211 as a specification here. For the transfer of the control of the longitudinal and/or lateral guidance of the vehicle 100 between different units 201, 204, a changeover can then be made between the different setpoint torques 211, 212 based on a changeover function 240 to determine a resulting setpoint torque 214 (as a specification for a vehicle actuator 103).

The changeover function 240, in particular the one or more time gradients for the changeover, can be specified (as shown by way of example by the arrow in FIG. 2a) by the first unit 201 (in particular by a driving function). The target value 202 for an acceleration can be defined by the first unit 201. This can be converted into a first setpoint torque 211 required for this purpose. Upon transfer of the control to the first unit 201, the resulting setpoint torque 214 can be changed over gradually (depending on the changeover function 240) from the second setpoint torque 212 to the first setpoint torque 211.

The changeover unit 210, as shown by way of example in FIG. 2a, can adopt the first setpoint torque 211, the second setpoint torque 212 and a changeover value (dependent on the changeover function 240) as input variables (at the individual points in time 220 of a sequence of successive points in time 220). The changeover value can be, for example, a value between 0 and 1. The resulting setpoint torque 214 at the output of the changeover unit 210 can be determined as a weighted mean value of the first setpoint torque 211 and the second setpoint torque. The first setpoint torque 211 can be weighted here using the value (a), and the second setpoint torque 212 can be weighted using the value (1-a), wherein a is the changeover value. The changeover value a can be changed over time 220 according to a changeover function 240 to effectuate a fluid changeover between the first setpoint torque 211 and the second setpoint torque 212.

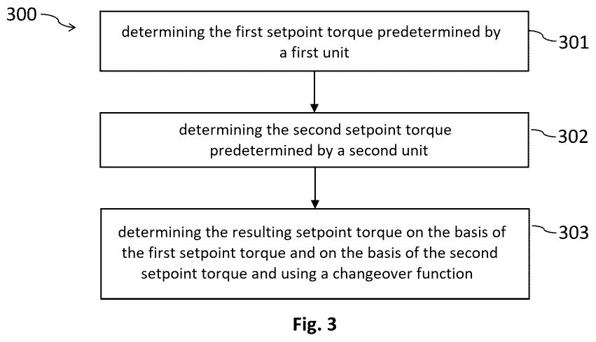

FIG. 3 shows a flow chart of a (possibly computer-implemented) method 300 for controlling the longitudinal and/or lateral guidance of a (motor) vehicle 100 by way of different units 201, 204. Exemplary units 201, 204 are a driving function for the automated longitudinal and/or lateral guidance, and also a control means 104 (such as the accelerator pedal, the brake pedal and/or the steering means) for the manual longitudinal and/or lateral guidance by the driver. The method 300 can be carried out by a control device 101, 200 of the vehicle 100.

The method 300 comprises the determination 301 of a first setpoint torque 211 (in particular a first setpoint wheel torque) predetermined by a first unit 201 as a specification for a longitudinal and/or lateral guidance actuator 103 of the vehicle 100. Exemplary actuators 103 are a drive motor, a brake actuator and/or a steering actuator of the vehicle 100. The first setpoint torque 211 can change over time 220.

The method 300 furthermore comprises the determination 302 of a second setpoint torque 212 (in particular a second wheel setpoint torque) predetermined by a second unit 204 as a specification for the longitudinal and/or lateral guidance actuator 103 of the vehicle 100. The second setpoint torque 212 can change over time 220.

Furthermore, the method 300 comprises the determination 303 of the resulting setpoint torque 214 (in particular the resulting wheel setpoint torque) to actuate the longitudinal and/or lateral guidance actuator 103 based on the first setpoint torque 211, based on the second setpoint torque 212 and based on a changeover function 240 for changing over between the first setpoint torque 211 and the second setpoint torque 212. The resulting setpoint torque 214 can be determined such that
the resulting setpoint torque 214 corresponds to the first setpoint torque 211 if the control of the longitudinal and/or lateral guidance is effectuated (solely) by the first unit 201;
the resulting setpoint torque 214 corresponds to the second setpoint torque 212 if the control of the longitudinal and/or lateral guidance is effectuated (solely) by the second unit 204;
the resulting setpoint torque 214 for a transition of the control from the first unit 201 to the second unit 202 (wherein the transition takes place at a specific point in time 221), the resulting setpoint torque 214 is changed over fluidly from the first setpoint torque 211 to the second setpoint torque 212 (in a time interval following the specific point in time 221, which is, for example, 0.5 seconds or longer, or 1 second or longer). The speed and/or the time progression of the changeover is defined by the changeover function 240; and/or
the resulting setpoint torque 214 for a transition of the control from the second unit 202 to the first unit 201 (wherein the transition takes place at a specific point in time 221), the resulting setpoint torque 214 is changed over fluidly from the second setpoint torque 212 to the first setpoint torque 211 (in a time interval following the specific point in time 221, which is, for example, 0.5 seconds or longer, or 1 second or longer). The speed and/or the time progression of the changeover is defined by the changeover function 240.

A particularly comfortable, robust and reliable transition of the control of the longitudinal and/or lateral guidance of a vehicle 100 between different (control) units 201, 204 can be effectuated by the measures described in this document.

The present invention is not restricted to the exemplary embodiments shown. In particular, it is to be noted that the description and the figures are only intended to illustrate the principle of the proposed methods, devices and systems by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device configured to control longitudinal and lateral guidance of a vehicle, wherein the device is configured to:
determine a first setpoint torque predetermined by a first unit as a specification for a longitudinal or lateral guidance actuator of the vehicle;
determine a second setpoint torque predetermined by a second unit as a specification for the longitudinal or lateral guidance actuator of the vehicle; and
determine a resulting setpoint torque for actuating the longitudinal or lateral guidance actuator based on the first setpoint torque, the second setpoint torque, and a changeover function for changing over between the first setpoint torque and the second setpoint torque.

2. The device according to claim 1, wherein
the changeover function specifies a changeover value as a function of time; and
the device is configured, at each point in time from a sequence of successive points in time, to:
determine the changeover value of the changeover function for a respective point in time; and
determine the resulting setpoint torque for the respective point in time based on the first setpoint torque for the respective point in time, the second setpoint torque for the respective point in time, and the changeover value for the respective point in time.

3. The device according to claim 2, wherein
the device is configured, at each point in time from a sequence of successive points in time, to determine the resulting setpoint torque for the respective point in time as a weighted mean value of the first setpoint torque for the respective point in time and the second setpoint torque for the respective point in time; and
weights for determining the weighted mean value depend on the changeover value for the respective point in time.

4. The device according to claim 3, wherein
the changeover function adopts changeover values between 0 and 1;
a first weight for weighting the first setpoint torque corresponds to the changeover value; and
a second weight for weighting the second setpoint torque corresponds to 1 minus the changeover value.

5. The device according to claim 1, wherein the device is configured to:
use the second setpoint torque as the resulting setpoint torque based on a determination that the longitudinal or lateral guidance of the vehicle is controlled by the second unit;
use the first setpoint torque as the resulting setpoint torque based on a determination that the longitudinal or lateral guidance of the vehicle is controlled by the first unit; and
in a transition of the control of the longitudinal or lateral guidance of the vehicle between the first unit and the second unit, use a value between the first setpoint torque and the second setpoint torque, which depends on a changeover value dependent on the changeover function, as the resulting setpoint torque.

6. The device according to claim 1, wherein the device is configured to:
determine at a first point in time that a transition of the control of the longitudinal or lateral guidance of the vehicle from the second unit to the first unit takes place; and
in reaction to the determination, in a time interval which extends from the first point in time to a second point in time, to change over the resulting setpoint torque from the second setpoint torque to the first setpoint torque depending on the changeover function.

7. The device according to claim 6, wherein
the changeover function specifies changeover values for the changeover between the first setpoint torque and the second setpoint torque as a function of time;
the changeover values of the changeover function in the time interval from the first point in time to the second point in time pass fluidly from a second value to a first value;
the resulting setpoint torque corresponds to the second setpoint torque based on a determination that the changeover value has the second value;
the resulting setpoint torque corresponds to the first setpoint torque based on a determination that the changeover value has the first value; and
the resulting setpoint torque has a value between the second setpoint torque and the first setpoint torque based on a determination that the changeover value is between the second value and the first value.

8. The device according to claim 7, wherein the changeover function has a changing time gradient in a time interval from the first point in time to the second point in time.

9. The device according to claim 1, wherein the device is configured to determine the first setpoint torque based on a setpoint acceleration predetermined by the first unit.

10. The device according to claim 1, wherein the first unit or the second unit comprises:
a driver assistance function for automated longitudinal or lateral guidance of the vehicle; or
an accelerator pedal, a brake pedal and a steering wheel for the manual longitudinal or lateral guidance of the vehicle by a driver of the vehicle.

11. The device according to claim 1, wherein the device is configured to operate the longitudinal or lateral guidance actuator depending on the resulting setpoint torque to guide the vehicle longitudinally or laterally.

12. A method for controlling longitudinal or lateral guidance of a vehicle, the method comprising:
determining a first setpoint torque predetermined by a first unit as a specification for a longitudinal or lateral guidance actuator of the vehicle;
determining a second setpoint torque predetermined by a second unit as a specification for the longitudinal or lateral guidance actuator of the vehicle; and
determining a resulting setpoint torque for actuating the longitudinal or lateral guidance actuator based on the first setpoint torque, the second setpoint torque, and a changeover function for a changeover between the first setpoint torque and the second setpoint torque.
